(19) United States
(12) Patent Application Publication
(10) Pub. No.: US 2025/0055219 A1
(43) Pub. Date: Feb. 13, 2025

(54) RIGHT-ANGLED CONNECTOR WITH TERMINAL RETENTION FEATURES

(71) Applicant: Aptiv Technologies AG, Schaffhausen (CH)

(72) Inventors: Wioleta BACHORZ, Kraków (PL); Piotr Najduch, Nowy Sacz (PL); Rainer Schmidt, Nürnberg (DE); Norbert Dobernig, Nuremberg (DE); Ricaedo J. Gomez, Nürnberg (DE); Michal Grudzewski, Kraków (PL)

(21) Appl. No.: 18/794,395

(22) Filed: Aug. 5, 2024

Related U.S. Application Data
(60) Provisional application No. 63/531,414, filed on Aug. 8, 2023.

(51) Int. Cl. H01R 13/506; H01R 13/426; H01R 13/58; H01R 43/20

(52) U.S. Cl. CPC H01R 13/506; H01R 13/426; H01R 13/582; H01R 43/20

(57) ABSTRACT

A right-angled connector is disclosed, including a connector housing with a forward stop surface designed to secure a right-angled terminal in a terminal cavity. The right-angled terminal features a connection section for interfacing with a corresponding terminal and an attachment section for conductor attachment. A cover, attached to the connector housing, encloses the terminal cavity and includes a rearward stop surface to limit the motion of the connection section to less than 0.5 mm along the connection axis. This design ensures precise positioning and retention of the right-angled terminal within the connector, enhancing stability and reliability of connections.

### CROSS-REFERENCE TO RELATED APPLICATIONS

This application claims the benefit of and priority to U.S. Provisional Application 63/531,414, titled “Right-Angle Female Connector Housing with Secondary Lock and Strain Relief Integrated with Cover”, filed Aug. 8, 2023, the contents of which are incorporated by reference herein.

### TECHNICAL FIELD OF THE INVENTION

This disclosure is directed to right-angle connectors, particularly to right-angled connectors with terminal retention features.

### BACKGROUND

Previous approaches to right-angled connectors have usually involved designs with a secondary terminal locking feature in the connector's housing. The secondary locking feature is closed to fix the position of the terminal in the housing by direct contact with the terminal or by blocking a primary terminal locking feature to prevent inadvertent disengagement of the primary locking feature. The secondary terminal locking feature's activation and assembly direction is typically from the bottom or the front sides of the connector housing. However, the limitations of these designs have been evident in the motion of the terminal within the housing along the connection axis, which has often exceeded acceptable tolerances, leading to terminal misalignment and connection issues. Additionally, the back of connector/terminal is not typically protected because there is no cover or cap provided to do so.

The need for right-angled connectors with improved stability and precision in limiting the motion of the terminal along the connection axis to ensure reliable and consistent connections remains unmet in the prior art. Various attempts have been made to enhance the design and functionality of right-angled connectors, but challenges persist in achieving the desired level of motion control within the connector housing. However, none of these approaches have provided a comprehensive solution that combines the features described in this disclosure.

### SUMMARY

The right-angled connector presented herein solves at least some of the problems of an unprotected back of connector and an exposed terminal found in other current concentor housing designs. The cover of this right-angled connector also pushes a terminal toward the front of connector, which significantly improves system performance in the following ways:
Enhances vibration performance;
Provides higher and more stable signal integrity performance;
Protects the terminal against damage and environmental contaminants;
Improves terminal fixation with less tilting inside the terminal cavity; and
Inhibits opening of the secondary locking features during bending of a cable attached to the terminal.

In addition, this right-angled connector is well suited for automated assembly.

In some aspects, the techniques described herein relate to a right-angled connector, including: a connector housing having a forward stop surface, the forward stop surface configured to retain a right-angled terminal within a terminal cavity in the connector housing, the right-angled terminal having a connection section configured to interface with a corresponding terminal along a connection axis and an attachment section configured to be attached to a conductor; and a cover attached to the connector housing, the cover configured to enclose the terminal cavity and defining a rearward stop surface configured to retain the right-angled terminal within the terminal cavity, the forward and rearward stop surfaces configured to limit motion of the connection section along the connection axis to less than 0.5 mm.

In some aspects, the techniques described herein relate to a method of assembling a right-angled connector, including: inserting a right-angled terminal configured to be attached to a conductor into a terminal cavity of a connector housing along an insertion direction, the connector housing including a forward stop surface bordering the terminal cavity; attaching a cover configured to enclose the terminal cavity to the connector housing along the insertion direction, the cover defining a rearward stop surface configured to retain the right-angled terminal within the terminal cavity; and disposing a portion of the right-angled terminal between the forward stop surface and the rearward stop surface.

### BRIEF DESCRIPTION OF THE DRAWINGS

FIG. 1 illustrates an exploded view of a right-angle electrical connector according to some embodiments.

FIG. 2 illustrates a side view of the right-angle electrical connector of FIG. 1 according to some embodiments.

FIG. 3 illustrates a close up view of a portion of the right-angle electrical connector indicated in FIG. 1 according to some embodiments.

FIG. 4 illustrates a cross-section view of the right-angle electrical connector of FIG. 1 according to some embodiments.

FIG. 5 illustrates a cross-section view of an alternative right-angle electrical connector according to some embodiments.

FIG. 6 illustrates an isometric view of a terminal of an alternative right-angle electrical connector according to some embodiments.

FIG. 7 illustrates an exploded view of an alternative right-angle electrical connector containing two terminals according to some embodiments.

FIG. 8 illustrates an exploded view of an alternative right-angle electrical connector containing four terminals according to some embodiments.

### DETAILED DESCRIPTION

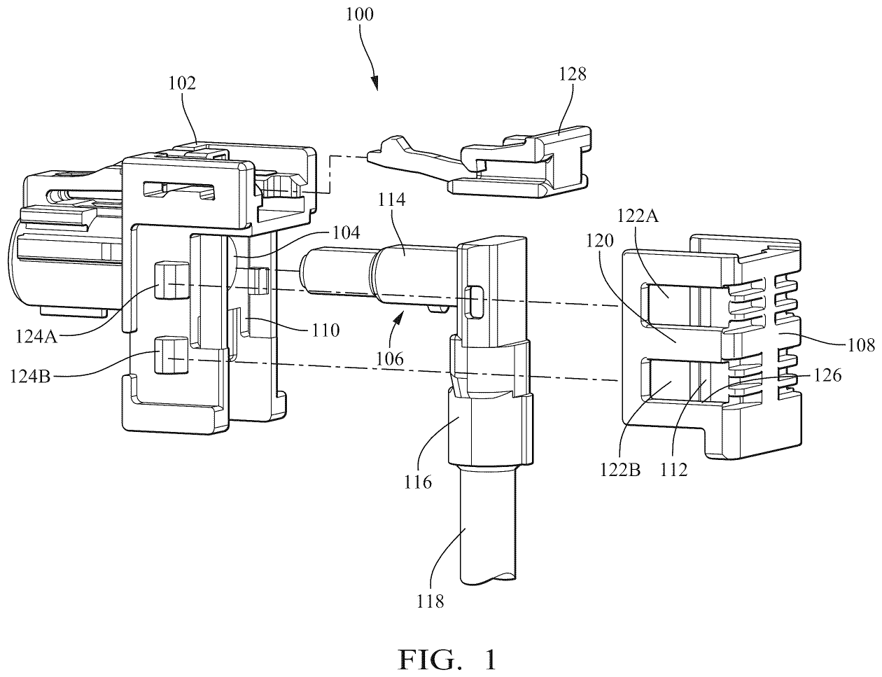

A non-limiting example of a right-angled connector 100 is shown in FIGS. 1-4. The illustrated example of FIGS. 1-4 is a single port right-angled female connector for a coaxial electrical cable. The connector 100 includes a connector housing 102 having a terminal cavity 104 that is configured to receive a right-angled coaxial electrical terminal 106. The connector housing 102 has a primary locking feature (not shown) that engages with corresponding features on the terminal 106 to retain the terminal 106 within the cavity 104. The connector housing 102 also includes a cover 108. The cover 108 attaches to the connector housing 102 to provide a secondary locking feature which further secures the terminal 106 within the cavity 104 and limits movement of the terminal 106 in the terminal cavity 104. The cover 108 also encloses the terminal 106 within the cavity 104 and protects the terminal 106 from inadvertent contact with foreign objects, such as tools as well as protecting the terminal 106 from exposure to environmental contaminants, such as water or dust which may degrade electrical performance of the connector 100.

The connector housing 102 defines a forward stop surface 110 that borders, i.e., is adjacent to, the terminal cavity 104. The cover 108 defines a rearward stop surface 112 which, together with the forward stop surface 110, provides the secondary terminal locking feature by limiting movement of the terminal 106 which may cause disengagement of the terminal 106 from the primary locking feature. The terminal 106 has a connection section 114 which extends along a connection axis X. The connection section 114 is configured to interface with a corresponding mating electrical terminal (not shown). The terminal 106 also has an attachment section 116 extending from the connection section 114 along an attachment axis Y that is substantially perpendicular to the connection axis X. As used herein, the term “substantially perpendicular” means 90°±5°. The attachment section 116 is configured to attach the terminal 106 to a coaxial electrical cable 118. The forward stop surface 110 and the rearward stop surface 112 cooperate to limit motion of the connection section along a connection axis of the terminal to less than 0.5 mm, preferably limiting motion to 0 mm.

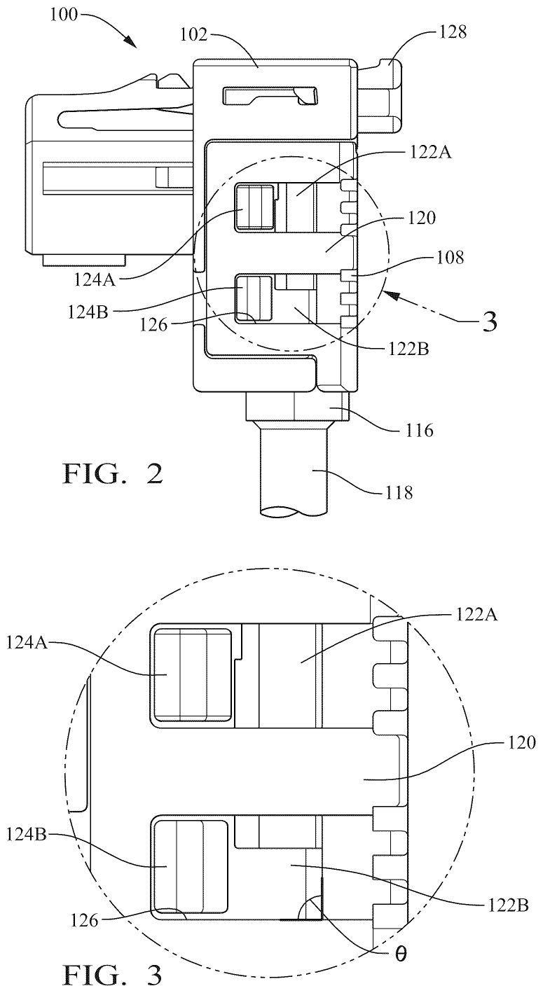

The cover 108 has latching arms 120 that are configured to attach the cover 108 to the connector housing 102 by engaging upper catches 124A and lower catches 124B extending from the connector housing 102. The latching arms 120 are defined on opposite sides of the connector housing 102. As shown in FIG. 2, the latching arms 120 extend along the connection axis X of the terminal 106 to fix the terminal 106 within the cavity 104. The latching arms 120 are also configured to discourage tilting of the terminal 106 within the cavity 104 due to lateral or longitudinal forces applied to the attached cable 118. The latching arms 120 define upper openings 122A and lower openings 122B in which the catches 124A, 124B are received. As shown in the close-up view of FIG. 3, edges 126 of the lower openings 122B define an acute angle θ and edges of the lower catches 124B received in the openings 122B define a substantially equivalent acute angle. The acute angle θ of the edges 126 is preferably within a range of 80 to 85 degrees. The acute angles of the edges 126 cooperate to resist the cover 108 from being pried from the housing 102 by contact between the cable 118 and the cover 108 due to forces applied to the cable 118. As used herein, the term “substantially equivalent acute angle” means that the acute angle of the edges of the catches 124B is ±2 degrees of the acute angle of the lower openings 122B in the latching arms 120.

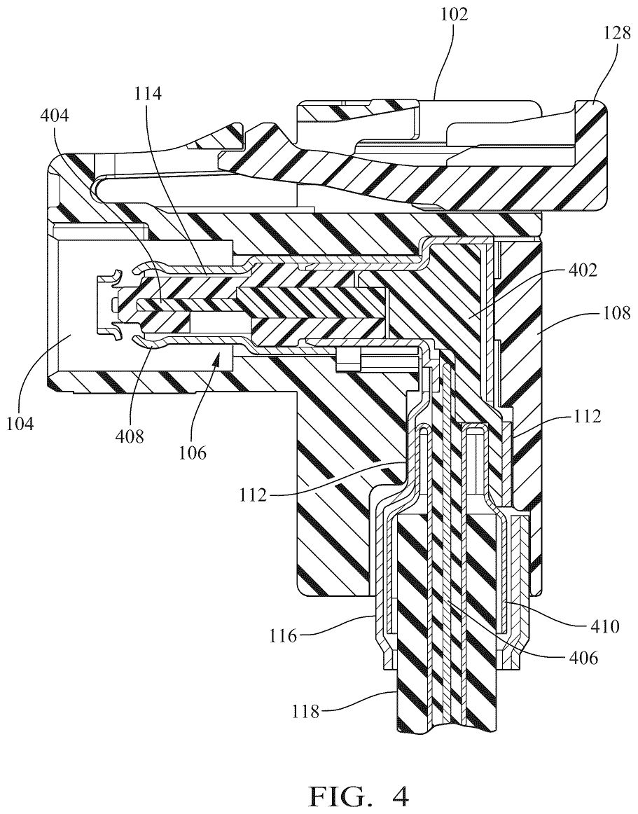

As best shown in FIG. 4, the connector housing 102 may optionally include a connector position assurance (CPA) device 128 configured to maintain a secure connection between the connector housing 102 and a corresponding connector housing (not shown) and a dielectric insulator 402 between a central terminal 404 of the terminal 106 connected to a central conductor 406 of the cable 118 and a shield terminal 408 of the terminal 106 connected to a shield conductor 410 of the cable 118.

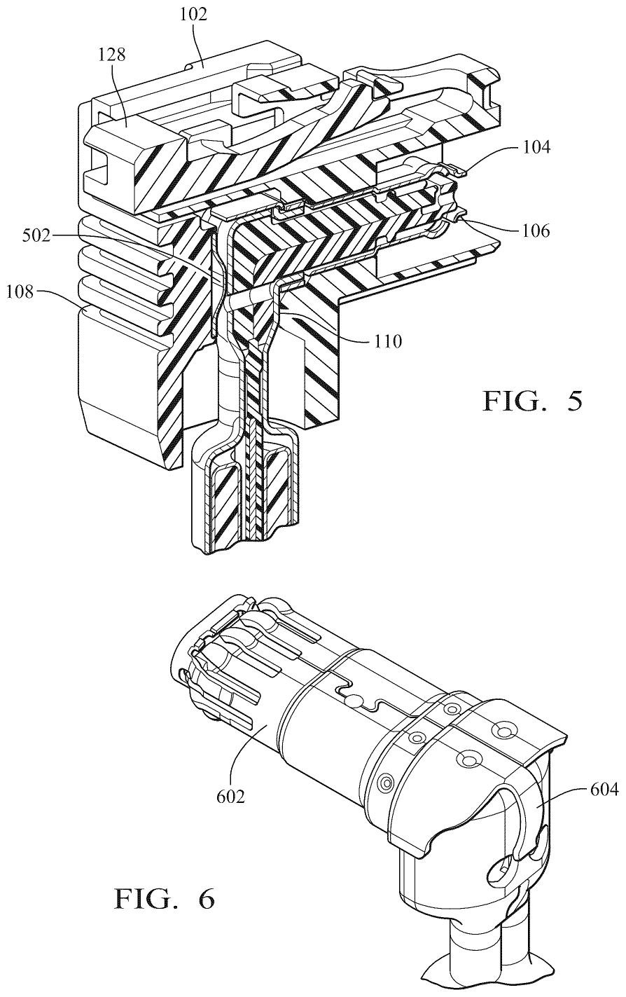

FIG. 5 illustrates an alternative embodiment of the right-angled connector 100 in which the cover 108 further includes a spring element 502 that is configured to bias the terminal 106 against the forward stop surface 110. In this example, the spring element 502 is a resilient dual metallic leaf spring that is disposed between the terminal and the cover. In alternative embodiments, the spring element 502 may formed of other resilient materials or designs and be attached to or embedded in the cover 108.

FIG. 6 illustrates a different embodiment of the right-angled connector 100 in which the terminal 602 includes a spring element 604 that is configured to push against the cover 108 and bias the right-angled terminal 602 against the forward stop surface 110.

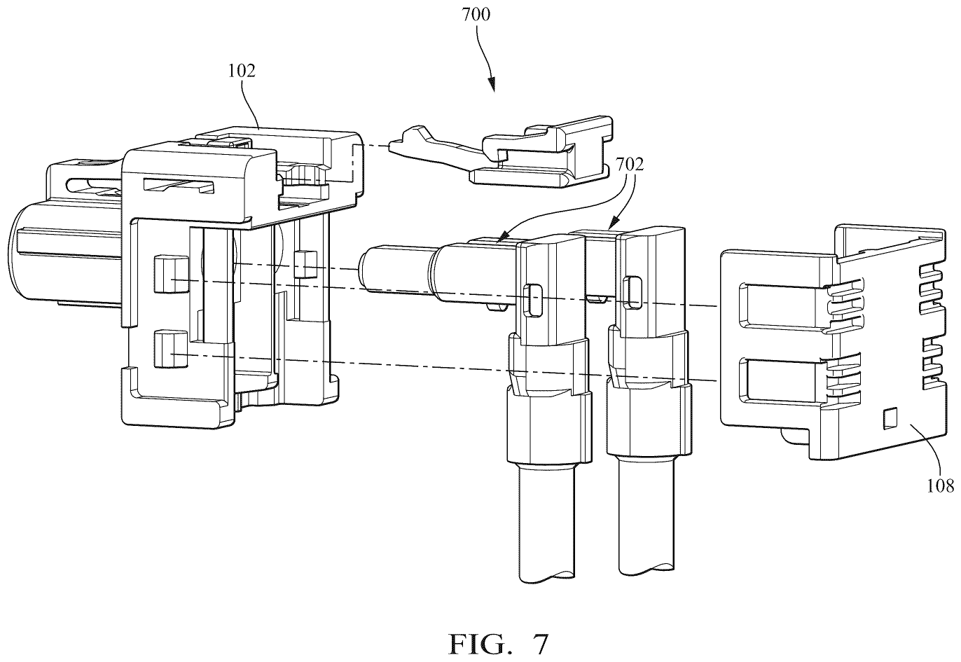

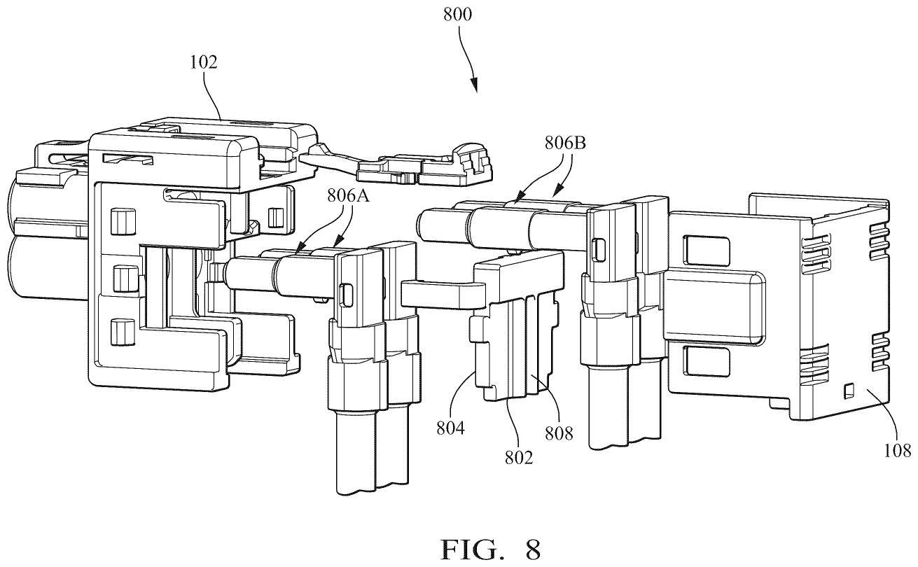

A dual port right-angle connector 700 configured to retain a pair of right-angled female terminals 702 is illustrated in FIG. 7 and a quad port dual row right-angle connector 800 configured to retain four right-angled female terminals is illustrated in FIG. 8. The quad port right-angle connector 800 further includes an inner cover 802 that provides a rearward stop surface 804 for two lower terminals 806A and a forward stop surface 808 for two upper terminals 806B.

These dual and quad port right-angle female connectors 700, 800 share many of the same features as the single port right-angle female connector 100 shown in the previous figures, particularly the primary locks and the secondary locks provided by the forward stop surfaces in the housing and the rearward stop surface in the cover.

The examples presented herein are directed to connectors and components thereof for electrical wiring. However, other embodiments of the right-angled connector may be envisioned that are adapted to connect other types of conductors besides electrical conductors, for example, fiber optic cables, pneumatic lines, hydraulic lines, or a hybrid connector containing a combination of any of these.

### Discussion of Possible Embodiments

The following are non-exclusive descriptions of possible embodiments of the present invention.

In some aspects, the techniques described herein relate to a right-angled connector, including: a connector housing having a forward stop surface, the forward stop surface configured to retain a right-angled terminal within a terminal cavity in the connector housing, the right-angled terminal having a connection section configured to interface with a corresponding terminal along a connection axis and an attachment section configured to be attached to a conductor; and a cover attached to the connector housing, the cover configured to enclose the terminal cavity and defining a rearward stop surface configured to retain the right-angled terminal within the terminal cavity, the forward and rearward stop surfaces configured to limit motion of the connection section along the connection axis to less than 0.5 mm, preferably 0 mm.

The connector of the preceding paragraph can optionally include, additionally and/or alternatively any, one or more of the following features/steps, configurations and/or additional components.

In some aspects, the techniques described herein relate to a connector, wherein the forward and rearward stop surfaces form a gap in which a portion of the attachment section may be disposed.

In some aspects, the techniques described herein relate to a connector, wherein the cover is configured to provide strain relief for the attachment section.

In some aspects, the techniques described herein relate to a connector, wherein the cover defines first latching arms and second latching arms that are configured to attach the cover to the connector housing by engaging first catches and second catches defined by the connector housing.

In some aspects, the techniques described herein relate to a connector, wherein the first latching arms and the second latching arms each define an opening in which the first catches and the second catches are received.

In some aspects, the techniques described herein relate to a connector, wherein edges of the openings in the second latching arms define an acute angle and edges of the second catches substantially define an equivalent acute angle.

In some aspects, the techniques described herein relate to a connector, wherein the acute angle is within a range of 80 to 85 degrees.

In some aspects, the techniques described herein relate to a connector, wherein the cover includes a spring element configured to bias the right-angled terminal against the forward stop surface.

In some aspects, the techniques described herein relate to a connector, wherein the right-angled terminal includes a spring element configured to bias the right-angled terminal against the forward stop surface.

In some aspects, the techniques described herein relate to a connector, wherein the right-angled terminal is an electrical terminal, and the conductor is an electrical conductor.

In some aspects, the techniques described herein relate to a connector, wherein the conductor is a coaxial electrical cable, and the right-angled terminal is configured to terminate the coaxial electrical cable.

In some aspects, the techniques described herein relate to a method of assembling a right-angled connector, including: inserting a right-angled terminal configured to be attached to a conductor into a terminal cavity of a connector housing along an insertion direction, the connector housing including a forward stop surface bordering the terminal cavity; attaching a cover configured to enclose the terminal cavity to the connector housing along the insertion direction, the cover defining a rearward stop surface configured to retain the right-angled terminal within the terminal cavity; and disposing a portion of the right-angled terminal between the forward stop surface and the rearward stop surface.

The method of the preceding paragraph can optionally include, additionally and/or alternatively any, one or more of the following features/steps, configurations and/or additional components.

In some aspects, the techniques described herein relate to a method, wherein the right-angled terminal includes a connection section configured to interface with a corresponding terminal along a connection axis and an attachment section configured to be attached to a conductor and wherein the connection axis is substantially parallel to the insertion direction.

In some aspects, the techniques described herein relate to a method, wherein the forward stop surface and the rearward stop surface cooperate to limit motion of the connection section along the connection axis to less than 0.5 mm.

In some aspects, the techniques described herein relate to a method, wherein the forward stop surface and the rearward stop surface form a gap and wherein the method further includes disposing a portion of the attachment section within the gap.

In some aspects, the techniques described herein relate to a method, wherein the method further includes biasing right-angled terminal against the forward stop surface using a spring clement defined by the cover.

In some aspects, the techniques described herein relate to a method, wherein the method further includes biasing right-angled terminal against the forward stop surface using a spring element defined by the right-angled terminal.

In some aspects, the techniques described herein relate to a method, wherein the cover defines first latching arms and second latching arms that are configured to attach the cover to the connector housing by engaging first catches and second catches defined by the connector housing, wherein the first latching arms and the second latching arms each define an opening in which the first catches and the second catches are disposed, and wherein edges of the openings in the second latching arms define an acute angle and edges of the second catches substantially define an equivalent acute angle.

In some aspects, the techniques described herein relate to a method, wherein the right-angled terminal is an electrical terminal, and the conductor is an electrical conductor.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, upper, lower, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”' is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A right-angled connector, comprising:
a connector housing having a forward stop surface, the forward stop surface configured to retain a right-angled terminal within a terminal cavity in the connector housing, the right-angled terminal having a connection section configured to interface with a corresponding terminal along a connection axis and an attachment section configured to be attached to a conductor; and
a cover attached to the connector housing, the cover configured to enclose the terminal cavity and defining a rearward stop surface configured to retain the right-angled terminal within the terminal cavity, the forward and rearward stop surfaces configured to limit motion of the connection section along the connection axis to less than 0.5 mm.

2. The connector according to claim 1, the forward and rearward stop surfaces cooperate to limit motion of the connection section along the connection axis to 0 mm.

3. The connector according to claim 1, wherein the forward and rearward stop surfaces form a gap in which a portion of the attachment section may be disposed.

4. The connector according to claim 1, wherein the cover is configured to provide strain relief for the attachment section.

5. The connector according to claim 1, wherein the cover defines first latching arms and second latching arms that are configured to attach the cover to the connector housing by engaging first catches and second catches defined by the connector housing.

6. The connector according to claim 5, wherein the first latching arms and the second latching arms each define an opening in which the first catches and the second catches are received.

7. The connector according to claim 6, wherein edges of the openings in the second latching arms define an acute angle and edges of the second catches substantially define an equivalent acute angle.

8. The connector according to claim 7, wherein the acute angle is within a range of 80 to 85 degrees.

9. The connector according to claim 1, wherein the cover comprises a spring element configured to bias the right-angled terminal against the forward stop surface.

10. The connector according to claim 1, wherein the right-angled terminal comprises a spring element configured to bias the right-angled terminal against the forward stop surface.

11. The connector according to claim 1, wherein the right-angled terminal is an electrical terminal, and the conductor is an electrical conductor.

12. The connector according to claim 1, wherein the conductor is a coaxial electrical cable, and the right-angled terminal is configured to terminate the coaxial electrical cable.

13. A method of assembling a right-angled connector, comprising:
inserting a right-angled terminal configured to be attached to a conductor into a terminal cavity of a connector housing along an insertion direction, the connector housing comprising a forward stop surface bordering the terminal cavity;
attaching a cover configured to enclose the terminal cavity to the connector housing along the insertion direction, the cover defining a rearward stop surface configured to retain the right-angled terminal within the terminal cavity; and
disposing a portion of the right-angled terminal between the forward stop surface and the rearward stop surface.

14. The method according to claim 13, wherein the right-angled terminal comprises a connection section configured to interface with a corresponding terminal along a connection axis and an attachment section configured to be attached to a conductor and wherein the connection axis is substantially parallel to the insertion direction.

15. The method according to claim 14, wherein the forward stop surface and the rearward stop surface cooperate to limit motion of the connection section along the connection axis to less than 0.5 mm.

16. The method according to claim 14, wherein the forward stop surface and the rearward stop surface form a gap and wherein the method further comprises disposing a portion of the attachment section within the gap.

17. The method according to claim 13, wherein the method further comprises biasing the right-angled terminal against the forward stop surface using a spring element defined by the cover.

18. The method according to claim 13, wherein the method further comprises biasing right-angled terminal against the forward stop surface using a spring element defined by the right-angled terminal.

19. The method according to claim 13, wherein the cover defines first latching arms and second latching arms that are configured to attach the cover to the connector housing by engaging first catches and second catches defined by the connector housing, wherein the first latching arms and the second latching arms each define an opening in which the first catches and the second catches are disposed, and wherein edges of the openings in the second latching arms define an acute angle and edges of the second catches substantially define an equivalent acute angle.

20. The method according to claim 13, wherein the right-angled terminal is an electrical terminal, and the conductor is an electrical conductor.
